(19) United States
(12) Patent Application Publication
(10) Pub. No.: US 2024/0144528 A1
(43) Pub. Date: May 2, 2024

(54) APPARATUS AND METHOD FOR DETERMINING POSITION OF CAPTURING OBJECT USING IMAGE INCLUDING CAPTURING OBJECT

(71) Applicant: CANON DENSHI KABUSHIKI KAISHA, Chichibu-shi (JP)

(72) Inventors: Takashi Goto, Fujisawa-shi (JP); Tomoya Inakawa, Tokyo (JP)

(21) Appl. No.: 18/492,812

(22) Filed: Oct. 24, 2023

(30) Foreign Application Priority Data
Oct. 31, 2022 (JP) 2022-174543
Oct. 13, 2023 (JP) 2023-177743

(51) Int. Cl. G06T 7/73; G06T 7/246; H04N 23/80

(52) U.S. Cl. CPC G06T 7/74; G06T 7/248; H04N 23/80; G06T 2207/10032; G06V 20/13

(57) ABSTRACT

An image processing circuit captures an image of an capturing object and obtain an image of the capturing object, detects brightness in each criteria region in the image, computes a difference in the brightness of two adjacent criteria regions, determines a position of the capturing object in the image corresponding to a pixel having a brightness greater than a predetermined value on a basis of the difference in the brightness.

### CROSS-REFERENCE TO RELATED APPLICATION(S)

This application claims priority to and the benefit of Japanese Patent Application No. 2022-174543 filed on Oct. 31, 2022, and Japanese Patent Application No. 2023-177743 filed on Oct. 13, 2023, the entire disclosure of which are incorporated herein by reference.

### BACKGROUND OF THE INVENTION

### Field of the Invention

The present disclosure relates to an apparatus and a method for determining the position of an capturing object using an image of the capturing object.

### Description of the Related Art

Spacecraft such as satellites and space probes are installed with a star tracker and detect the positions of stars using the star tracker to determine the attitude of the spacecraft on the basis of the detected positions of the stars. A star tracker is one type of spacecraft attitude sensor and includes an image sensor for capturing images of stars. A star tracker detects the positions of stars on the basis of the star images captured by the image sensor.

Then, the star tracker can compare the star positions obtained as detection results with the star positions in a star catalogue, identify the stars, and determine the attitude of the spacecraft.

With a known star tracker, when the sun enters the field of view or an angle outside of the field of view with solar interference, the overall brightness of the captured image is increased, making determination (detection) of stars difficult. As a result, it makes attitude determination difficult. Accordingly, when a known star tracker is used, the range of the field of view used needs to be such that the brightness of a location other than a star is sufficiently less than a threshold used in star determination.

Also, a known star tracker stores image data output from an image sensor in memory unprocessed, and after storing, a computing apparatus accesses the memory and executes processing on the image data to detect a star position (Japanese Patent Laid-Open No. H7-270177).

Another known star tracker divides image data output from an image sensor into a plurality of blocks as pre-memory-storage processing and detects whether or not a star is in each block on the basis of the number of pixels with a brightness greater than a preset threshold. A computing apparatus of this known star tracker accesses only regions around each block to detect a star position (Japanese Patent Laid-Open No. H11-291996).

However, a computing apparatus of a known star tracker accesses all of the memory where image data is stored or accesses all of the blocks determined to have a star when image processing is executed. This makes image processing take a long time. Also, when the sun is positioned in or near the angle of view, the overall brightness of the image is increased. Thus, many blocks may be determined to have a star present. As a result, the computing apparatus needs to access many blocks.

Note that such problems may also occur when both the capturing object and an object with high brightness are present in the field of view of the image sensor and when the capturing object is present in the field of view and an object with high brightness is outside of the field of view but located in or near the angle of view. For example, with a manufacturing apparatus that manufactures a certain item, when inspecting for foreign objects (in particular, foreign objects with high brightness) adhered to the item, objects with high brightness may increase an image processing time for discriminating the foreign objects with foreign objects and the objects with high brightness. The present invention reduces a processing time for estimating the position of a capturing object.

### SUMMARY OF THE INVENTION

The present disclosure provides an image processing circuit comprising:

an image capture unit configured to capture an image of an capturing object and obtain an image of the capturing object;

a brightness detection unit configured to detect brightness in each criteria region in the image obtained by the image capture unit;

a computation unit configured to compute a difference in the brightness of two adjacent criteria regions detected by the brightness detection unit; and

a position determination unit configured to determine a position of the capturing object in the image corresponding to a pixel having a brightness greater than a predetermined value on a basis of the difference in the brightness computed by the computation unit.

### BRIEF DESCRIPTION OF THE DRAWINGS

FIG. 1 is a block diagram illustrating a hardware configuration of a star tracker according to a first embodiment.

FIG. 2 is a block diagram illustrating a hardware configuration of an FPGA included in the star tracker illustrated in FIG. 1.

FIG. 3 is a block diagram illustrating a hardware configuration of a data processing unit included in the FPGA illustrated in FIG. 2.

FIG. 4 is a timing chart illustrating the operations executed by the data processing unit illustrated in FIG. 3.

FIG. 5 is a block diagram illustrating a hardware configuration of a star position searching unit included in the FPGA illustrated in FIG. 2.

FIG. 6 is a block diagram illustrating a hardware configuration of a brightness difference calculation unit included in the star position searching unit illustrated in FIG. 5.

FIG. 7 is a flowchart illustrating the processing executed by a brightness gradient width measurement unit.

FIG. 8 is a flowchart illustrating the processing executed by a peak determination unit and a data buffer.

FIG. 9 is a flowchart illustrating the processing executed by a valley determination unit, a top candidate determination unit, and a top candidate storage unit.

FIG. 10 is a flowchart illustrating the processing executed by a top determination unit and RAM for star position information storage.

FIG. 11 is a diagram for describing an example of processing in the star position searching unit.

FIG. 12 is a block diagram illustrating a hardware configuration of the star position searching unit according to a second embodiment.

FIG. 13 is a flowchart illustrating the processing executed by the valley determination unit, the top candidate determination unit, and the top candidate storage unit.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

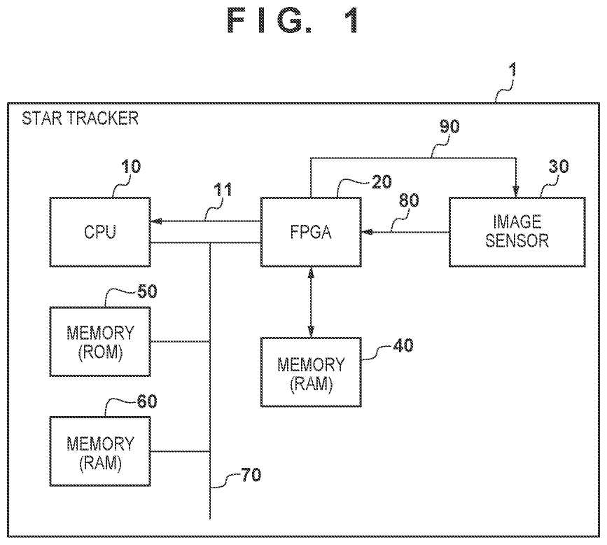

The first embodiment will be described below with reference to FIGS. 1 to 11. FIG. 1 is a block diagram illustrating a hardware configuration of a star tracker according to the first embodiment. A star tracker (STT) 1 illustrated in FIG. 1 is capable of being installed in a spacecraft that fly through space and is an apparatus that captures images of stars in space and obtains the attitude (direction) of the spacecraft. The term spacecraft is not particularly limited and examples include an unmanned spacecraft such as a satellite or orbiter and a manned spacecraft such as a space probe, a space shuttle, or a space station.

The star tracker 1 includes a central processing unit (CPU) 10 and a field programmable gate array (FPGA) or an application specific Integrated Circuit (ASIC) 20. The star tracker 1 also includes an image sensor (image capture unit) 30, random access memory (RAM) 40, read only memory (ROM) 50, and RAM 60. These components forming the star tracker 1 are communicatively connected to one another.

The image sensor 30 captures an image of a star (image capture process). The image sensor 30 is an element including an imaging surface (not illustrated) for capturing an image of a star and is constituted of a complementary metal oxide semiconductor (CMOS) image sensor, a charge coupled device (CCD) image sensor, or another element.

Note that in the present embodiment, the external shape of the imaging surface of the image sensor 30 is a rectangle. The image sensor 30, in sync with a pixel clock, converts light incident on the imaging surface into an electrical signal, perform analog-to-digital (A/D) conversion of the electrical signal to generate image data, and outputs the image data to an image bus 80. Image processing is executed on the image data using an image processing circuit constituted by the FPGA 20 or ASIC. The image data may be referred to as pixel data.

The FPGA 20 is communicatively connected to the image sensor 30 and control capturing the image data output from the image sensor 30. With this control, for example, a vertical synchronizing signal, a horizontal synchronizing signal, and a pixel clock are transmitted from the FPGA 20 to the image sensor 30. The FPGA 20 sequentially writes the digital data obtained by executing image processing on the image data to the RAM 40.

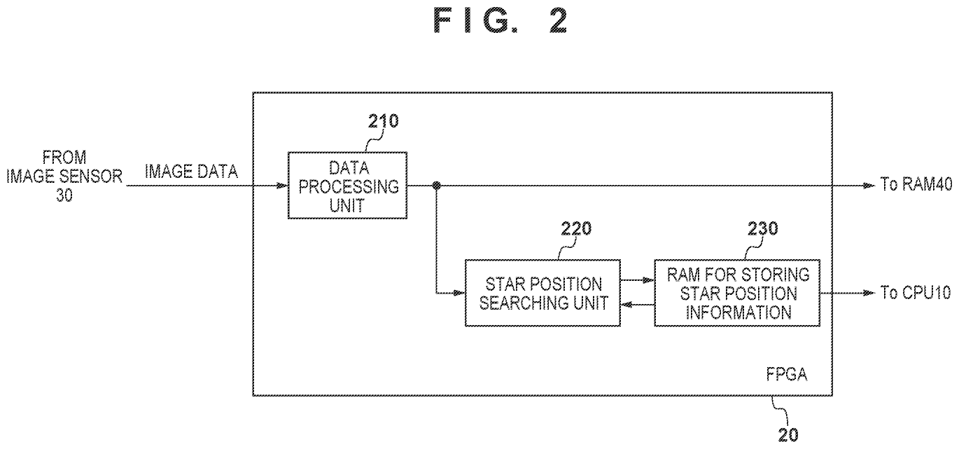

The FPGA 20, with the writing, executes a brightness detection process, a computation process, and a position estimation process described below. Then, the FPGA 20 stores the star position information obtained by executing these processes in RAM 230 (see FIG. 2) for star position information storage inside the FPGA 20. The FPGA 20 repeats this for each frame, and when the processing has ended, an image capture completion signal 11 is output to the CPU 10. In other words, the image capture completion signal 11 is transmitted.

The ROM 50 stores various types of programs executed by the CPU 10. These various types of programs include, for example, a program (a star position estimation program for executing a star position estimation method) for making the computer constituted by the CPU 10, the FPGA 20, and the like to function as the components and units of the star tracker 1 and the like. The RAM 60 is the working memory of the CPU 10.

The CPU 10 performs various types of control such as controlling the operations of the FPGA 20, controlling the operations of the image sensor 30 (shutter speed control), and the like. Specifically, the CPU 10 sets the gain data of the image sensor 30 and the timing data indicating the on or off timing for image capture for the FPGA 20 via a system bus 70. The FPGA 20 converts the set data into a serial signal 90 and sets it for the image sensor 30. In this manner, the image sensor 30 is made able to execute image capture.

When the CPU 10 receives the image capture completion signal 11 from the FPGA 20, the CPU 10 reads the star position information in the RAM 230 for star position information storage. The CPU 10 extracts pixel data around the star position from the RAM 40 using the star position information and further obtains an accurate star position via a centroid calculation or the like. The CPU 10 calculates a plurality of distances between stars by repeating this processing. The CPU 10 compares the calculation results with a star map (star catalogue) prestored in the ROM 50 and estimates the attitude of the spacecraft. In this manner, in the present embodiment, the CPU 10 functions as an attitude estimation unit for estimating the attitude of the spacecraft.

FIG. 2 is a block diagram illustrating a hardware configuration of the FPGA 20 included in the star tracker illustrated in FIG. 1. As illustrated in FIG. 2, the FPGA 20 includes a data processing unit 210, a star position searching unit 220, and the RAM 230 for star position information storage.

As illustrated in FIG. 2, the image data output from the image sensor 30 is input into the data processing unit 210. The data processing unit 210 executes image processing on the input image data and outputs the processed image data to the RAM 40 and the star position searching unit 220. The star position searching unit 220 executes processing on the image data to search for the position of a star described below. In a case where a top (star) candidate is detected via the processing, the star position searching unit 220 compares the position of the top (star) candidate and the pixel positions determined to be top candidates until now stored in the RAM 230 for star position information storage.

In some cases, there may be no information relating to star positions stored in the RAM 230 for star position information storage. In this case, the star position information and brightness are stored in the RAM 230 for star position information storage.

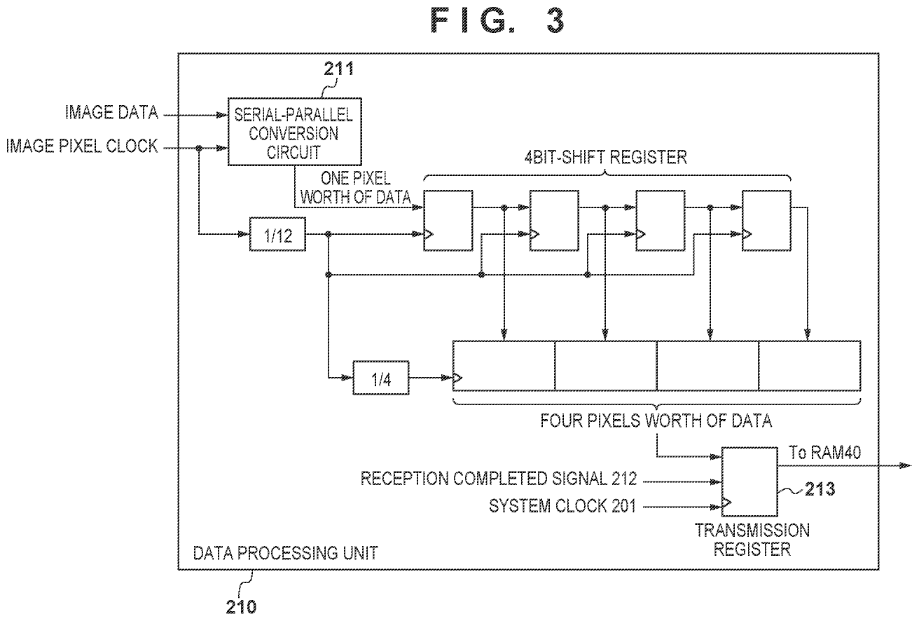

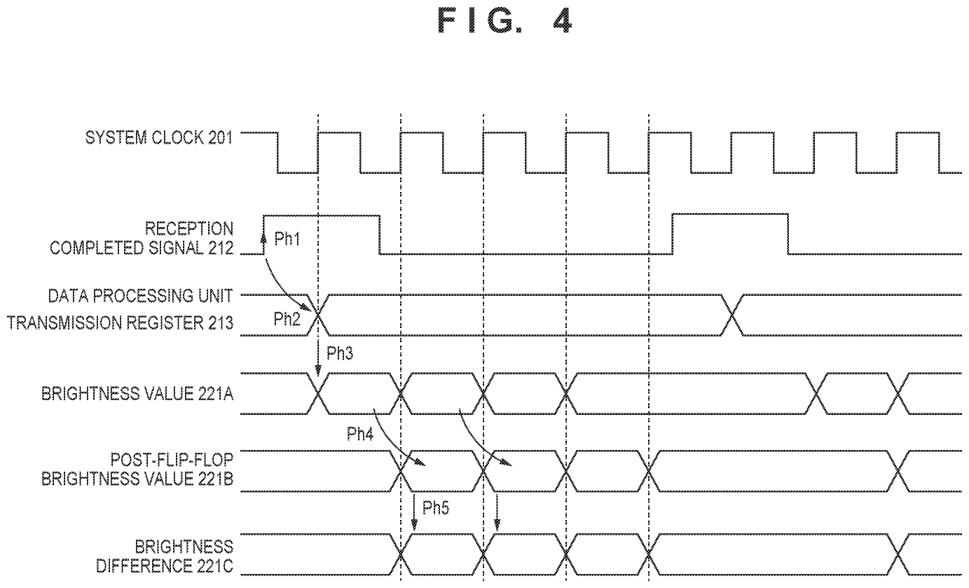

FIG. 3 is a block diagram illustrating a hardware configuration of the data processing unit 210 included in the FPGA 20 illustrated in FIG. 2. FIG. 4 is a timing chart illustrating the timing of the operations executed by the data processing unit 210 illustrated in FIG. 3. As illustrated in FIG. 3, the data processing unit 210 includes a serial-parallel conversion circuit 211 and a transmission register 213. The pixel data and the pixel clock output from the image sensor 30 are input into the serial-parallel conversion circuit 211.

The serial-parallel conversion circuit 211 outputs one pixel data converted into a parallel signal to the shift register. Also, the data is latched by the clock generated by dividing the pixel clock. For example, in a case where the brightness value (gray scale value) of one pixel is expressed in 12 bits, the pixel clock is divided into 12. In the present embodiment, the number of sequential logic circuits implemented is the same as the number of pixels transmitted to the RAM 40 at a communication. For example, when the number of pixels transmitted to the RAM 40 is four, four sequential logic circuits are implemented.

The sequential logic circuits shift the pixel data in accordance with the pixel clock divided into 12 and, when four pixels data is accumulated, latches the four pixels data in accordance with the clock divided by the transmission pixel number by four. At this time, a reception completed signal 212 is high (see “Ph1” in FIG. 4). Also, the latched four pixels data is output to the transmission register 213. When the reception completed signal 212 is high, at a rise in a system clock 201, the transmission register 213 latches the input four pixels pixel data (see “Ph2” in FIG. 4) and outputs this to the RAM 40.

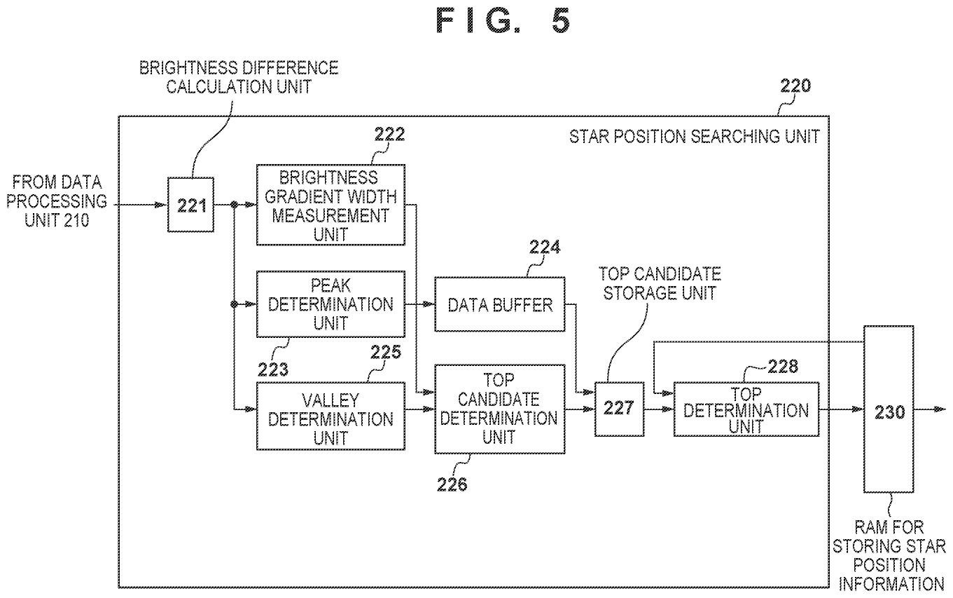

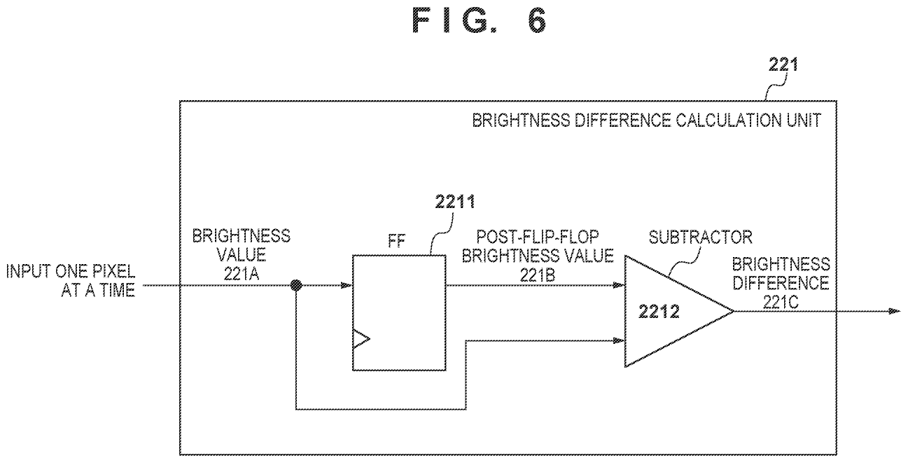

FIG. 5 is a block diagram illustrating a hardware configuration of the star position searching unit 220 included in the FPGA 20 illustrated in FIG. 2. FIG. 6 is a block diagram illustrating a hardware configuration of a brightness difference calculation unit 221 included in the star position searching unit 220 illustrated in FIG. 5. As illustrated in FIG. 5, the star position searching unit 220 includes the brightness difference calculation unit 221, a brightness gradient width measurement unit 222, a peak determination unit 223, a data buffer 224, a valley determination unit 225, a top candidate determination unit 226, a top candidate storage unit 227, and a top determination unit 228. The peak determination unit 223 can be called as a local maximum determination unit. The top candidate determination unit 226 can be called as a summit determination unit or a maximum determination unit. The valley determination unit 225 can be called as a local minimum determination unit or a trough determination unit.

As illustrated in FIG. 6, the brightness difference calculation unit 221 includes a flip-flop (FF) 2211 and a subtractor 2212. As described above, the data processing unit 210 transmits the processed image data to the RAM 40 (see FIG. 2). At this time, the brightness difference calculation unit 221 inputs brightness information relating to the brightness of pixels in the image data from the data processing unit 210.

As illustrated in FIG. 6, the FF 2211 and the subtractor 2212 are each input with a brightness value 221A (see “Ph3” in FIG. 4) per pixel. Thereafter, the FF 2211 outputs a value latched at the rise of the system clock 201 to the subtractor 2212 as a post-flip-flop brightness value 221B (see “Ph4” in FIG. 4).

The subtractor 2212 calculates a brightness difference 221C of pixels adjacent in the read direction by calculating the difference between the brightness value 221A and the brightness value 221B (see “Ph5” in FIG. 4). The brightness difference 221C calculated by the brightness difference calculation unit 221 is input into the brightness gradient width measurement unit 222, the peak determination unit 223, and the valley determination unit 225 and is processed in parallel at these units.

As described above, the brightness difference calculation unit 221 detects the brightness (brightness value) per pixel in the image captured by the image sensor 30 and calculates the difference in brightness between two adjacent pixels. By detecting the brightness per pixel, the brightness of the star image captured by the image sensor 30 can be detected in as finer detail as possible, that is at as many points as possible.

Note that criteria region for brightness detection in the star image may be one pixel in the image. However, this is merely an example. The criteria region may be formed by a plurality of adjacent pixels, for example.

The brightness difference calculation unit 221, when detecting brightness, reads each pixel in order in the read out direction from the image sensor 30. Then, the brightness difference calculation unit 221, when calculating the brightness difference, can output a value obtained by subtracting the brightness of one pixel located behind in the reading direction from the brightness of one pixel located in front in the reading direction at the time of brightness detection to the brightness gradient width measurement unit 222, the peak determination unit 223, and the valley determination unit 225 as the brightness difference (difference in brightness).

Accordingly, in the present embodiment, the brightness difference calculation unit 221 (FPGA 20) includes the function of a brightness detection unit that detects brightness and a calculation unit that calculates the brightness difference. Note that the read out unit of the image sensor 30 may be the entire star image or a portion of the entire star image. It is sufficient that brightness difference calculation unit 221 executes reading of a region read out by the image sensor 30 in the same direction as the read out direction of the region.

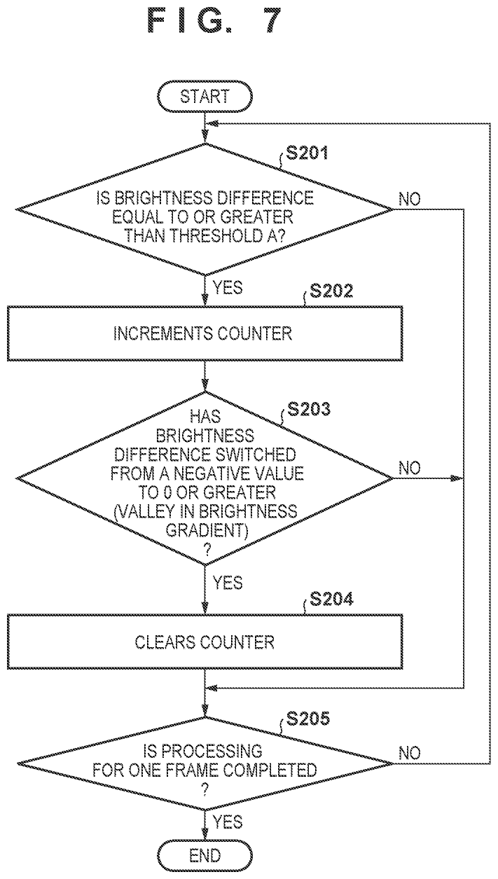

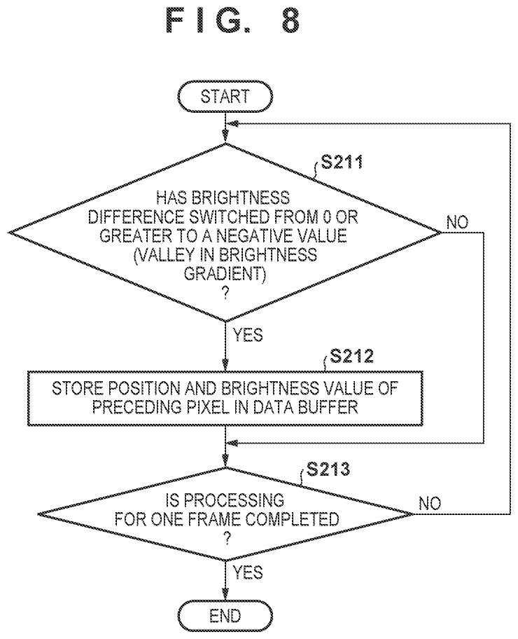

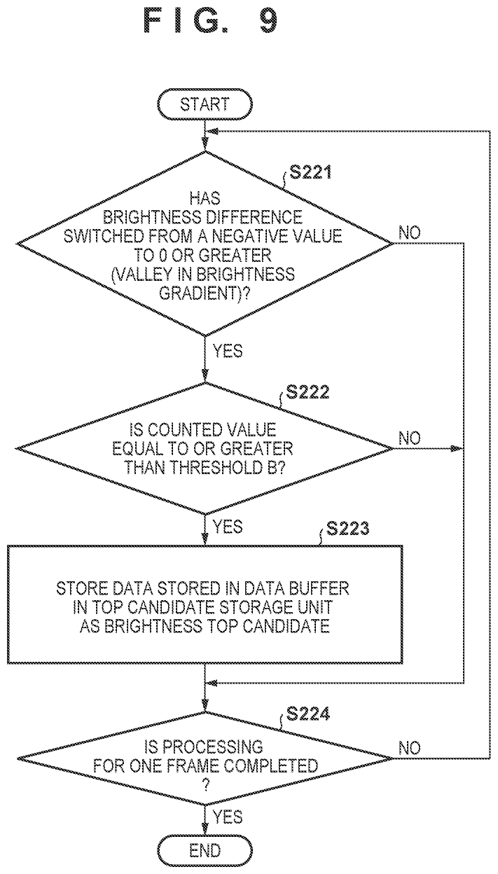

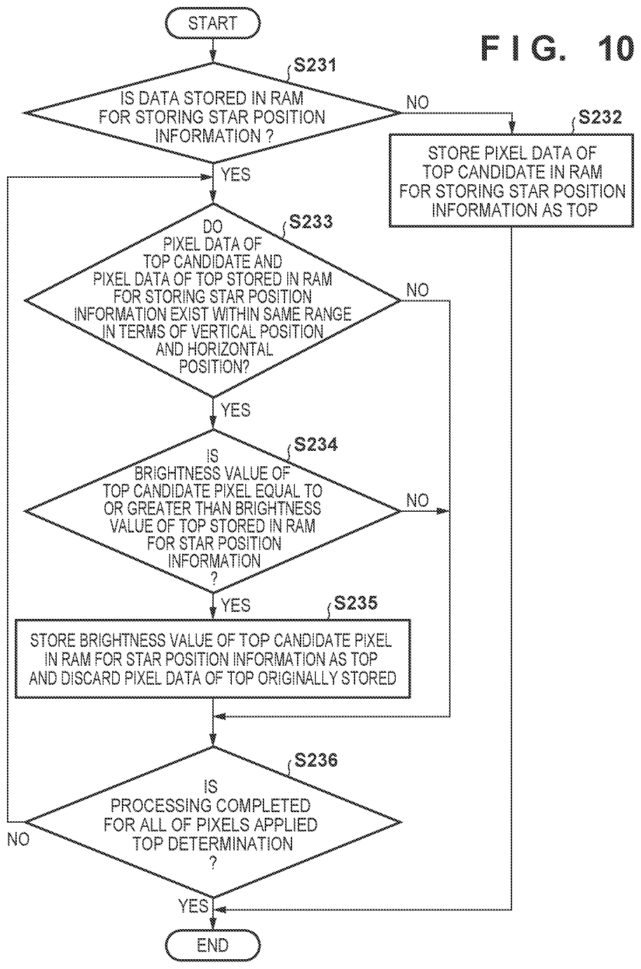

FIG. 7 is a flowchart illustrating the processing executed by the brightness gradient width measurement unit 222. FIG. 8 is a flowchart illustrating the processing executed by the peak determination unit 223 and the data buffer 224. FIG. 9 is a flowchart illustrating the processing executed by the valley determination unit 225, the top candidate determination unit 226, and the top candidate storage unit 227. FIG. 10 is a flowchart illustrating the processing executed by the top determination unit 228 and the RAM 230 for star position information storage. Hereinafter, when the read out direction of the image is from the left to the right, the left side is referred to as the front and the right side is referred to as behind. Of two adjacent pixels, the pixel located in front in the read out direction is referred to as the “target pixel” and the pixel located behind in the read out direction is referred to as the “preceding pixel”.

As illustrated in FIG. 7, in step S201, in a case where the brightness difference between the target pixel and the preceding pixel is input into the brightness gradient width measurement unit 222, the brightness gradient width measurement unit 222 determines whether or not the brightness difference is equal to or greater than a threshold (hereinafter referred to as “threshold A”). The threshold A is set to a value that enables noise or the brightness difference corresponding to a dark star to be excluded so that only the pixels with a brightness difference equal to or greater than the threshold A are taken as the target for the processing described below as a top candidate.

Note that as the threshold A, for example, a threshold preset at the time of FPGA configuration may be used or a threshold set from the CPU 10 via the system bus 70 may be used. In a case where the result of the determination in step S201 is that the brightness difference is equal to or greater than the threshold A, the processing proceeds to step S202. On the other hand, in a case where the result of the determination in step S201 is that the brightness difference is not equal to or greater than the threshold A, the processing proceeds to step S205.

In step S202, the brightness gradient width measurement unit 222 increments a brightness gradient width counter by one, and the processing proceeds to step S203.

In step S203, the brightness gradient width measurement unit 222 determines whether or not the brightness difference switched from a negative value to 0 or greater, that is, whether or not a valley in the brightness gradient found. In a case where the result of the determination in step S203 is that the brightness difference has switched from a negative value to 0 or greater, the processing proceeds to step S204. On the other hand, in a case where the result of the determination in step S203 is that the brightness difference has not switched from a negative value to 0 or greater, the processing proceeds to step S205.

In step S204, the brightness gradient width measurement unit 222 stores the count value of the brightness gradient width counter in a storage apparatus (for example, the RAM 40) and clears the brightness gradient width counter to 0.

In step S205, the brightness gradient width measurement unit 222 determines whether or not the processing up to step S204 has been completed for one whole frame. In a case where the result of the determination in step S205 is that one whole frame has been completed, the processing ends. On the other hand, in a case where the result of the determination in step S205 is that one whole frame has not been completed, the brightness gradient width measurement unit 222 changes the target pixel to the next (succeeding) pixel, returns the processing to step S201, and executes the following steps in order.

In this manner, the brightness gradient width measurement unit 222 uses the brightness difference to check the brightness gradient in the read out direction and measures the width of the brightness gradient, that is, the width of the image made by the star. Also, by appropriately setting the threshold A, the noise in the star image is removed. Accordingly, the brightness gradient can be made able to be accurately comprehended.

As illustrated in FIG. 8, in step S211, in a case where the brightness difference is input, the peak determination unit 223 determines whether or not the brightness difference has switched from 0 or greater to a negative value, that is, whether or not a peak (local maximum of brightness) in the brightness gradient has been detected as a tendency in the brightness gradient. In a case where the result of the determination in step S211 is that the brightness difference has switched from 0 or greater to a negative value, the processing proceeds to step S212. On the other hand, in a case where the result of the determination in step S211 is that the brightness difference has not switched from 0 or greater to a negative value, the processing proceeds to step S213.

In step S212, the peak determination unit 223 stores the position of the preceding pixel and the brightness value in the data buffer 224 functioning as a storage apparatus (causes to be stored). The preceding pixel is a preceding pixel of when the brightness difference switched from 0 or greater to a negative value and corresponds to the pixel with the highest brightness in the surrounding pixel group including the preceding pixel. In step S212, since there is a possibility that the brightness value of the preceding pixel corresponds to a top brightness (maximum of brightness), the brightness value of the preceding pixel is temporarily stored in the data buffer 224.

In step S213, the peak determination unit 223 determines whether or not the processing up to step S212 has been completed for one whole frame. In a case where the result of the determination in step S213 is that one whole frame has been completed, the processing ends. On the other hand, in a case where the result of the determination in step S213 is that one whole frame has not been completed, the peak determination unit 223 changes the target pixel to the next pixel, returns the processing to step S211, and executes the following steps in order.

As illustrated in FIG. 9, in step S221, in a case where the brightness difference is input, the valley determination unit 225 determines whether or not the brightness difference has switched from a negative value to 0 or greater, that is, whether or not a valley in the brightness gradient has been detected as a tendency in the brightness gradient. In a case where the result of the determination in step S221 is that the brightness difference has switched from a negative value to 0 or greater, the processing proceeds to step S222. On the other hand, in a case where the result of the determination in step S221 is that the brightness difference has not switched from a negative value to 0 or greater, the processing proceeds to step S224.

In step S222, the valley determination unit 225 checks the value of the brightness gradient width counter of the brightness gradient width measurement unit 222 and determines whether or not the count value is equal to or greater than a threshold (hereinafter referred to as “threshold B”). Note that as with the threshold A, for example, a threshold preset at the time of FPGA configuration may be used or a threshold set from the CPU 10 via the system bus 70 may be used. In a case where the result of the determination in step S222 is that the count value is equal to or greater than the threshold B, the processing proceeds to step S223. On the other hand, in a case where the result of the determination in step S222 is that the count value is not equal to or greater than the threshold B, the processing proceeds to step S224.

In step S223, the top candidate determination unit 226 stores the pixel data corresponding to the peak (local maximum) in the brightness gradient stored in the data buffer 224 in the top candidate storage unit 227 as a brightness top candidate. In other words, each time a valley in the brightness gradient is detected, the size of the image of the star is checked, and if the value of the brightness gradient width counter is equal to or greater than the threshold B, the brightness value (pixel data) is stored in the top candidate storage unit 227 as a brightness top candidate. The size of the star image can be estimated in advance on the basis of the sensor sensitivity, the f-number, the shutter speed, and the like, for example. Thus, by appropriately setting the threshold B, portions in the star image with relatively high brightness compared to the brightness of the surrounding pixels can be distinguished as a star image or as noise or the like.

In step S224, the top candidate determination unit 226 determines whether or not the processing up to step S223 has been completed for one whole frame. In a case where the result of the determination in step S224 is that one whole frame has been completed, the processing ends. On the other hand, in a case where the result of the determination in step S224 is that one whole frame has not been completed, the top candidate determination unit 226 changes the target pixel to the next pixel, returns the processing to step S221, and executes the following steps in order.

As illustrated in FIG. 10, in step S231, in a case where the pixel data stored in step S223 is input into the top determination unit 228 from the top candidate storage unit 227, the top determination unit 228 determines whether or not the data is already stored as a top (maximum brightness) in the RAM 230 for star position information storage. In a case where the result of the determination in step S231 is that the data is stored in the RAM 230 for star position information storage, the processing proceeds to step S233. On the other hand, in a case where the result of the determination in step S231 is that the data is not stored in the RAM 230 for star position information storage, the processing proceeds to step S232.

In step S232, the top determination unit 228 determines the pixel data of the top candidate input in step S231 as a top and stores it in the RAM 230 for star position information storage. After step S232 is performed, the processing ends.

In step S233, the top determination unit 228 compares the vertical position and horizontal position of the pixel data of the top candidate input in step S231 and the pixel data of the top stored in the RAM 230 for star position information storage. Then, the top determination unit 228 determines whether or not the position of each pixel data exists in a preset range (hereinafter referred to as “range C”). Note that as with the threshold A and the threshold B, for example, as the range C, a range preset at the time of FPGA configuration may be used or a range set from the CPU 10 via the system bus 70 may be used. In a case where the result of the determination in step S233 is that the position of each pixel data exists in the range C, the processing proceeds to step S234. On the other hand, in a case where the result of the determination in step S233 is that the position of each pixel data does not exist in the range C, the processing proceeds to step S236.

In step S234, the top determination unit 228 determines whether or not the brightness value of the top candidate pixel is equal to or greater than the brightness value of the top stored in the RAM 230 for star position information storage. In a case where the result of the determination in step S234 is that the brightness value of the top candidate pixel is equal to or greater than the brightness value of the top, the processing proceeds to step S235. On the other hand, in a case where the result of the determination in step S234 is that the brightness value of the top candidate pixel is not equal to or greater than the brightness value of the top, the processing proceeds to step S236.

In step S235, the top determination unit 228 stores the brightness value of the top candidate pixel in the RAM 230 for star position information storage as the top and discards the pixel data (brightness value) of the top originally stored.

In step S236, the top determination unit 228 determines whether or not the processing up to step S235 has been completed for all of the pixels stored in the top candidate storage unit 227 and determined to be a top candidate. In a case where the result of the determination in step S236 is that the processing has been completed, the processing ends. On the other hand, in a case where the result of the determination in step S236 is that the processing has not been completed, the processing returns to step S233, and the following steps are executed in order.

Accordingly, a pixel determined to a new top candidate and a pixel determined to a top up to now may indicate the same star. In this case, at the top determination unit 228, processing to merge the two pixels originating from the same star is executed.

The processing of the star position searching unit 220 described above is executed for each pixel (each line). Thus, in a case where a star is captured spanning across a plurality of pixels in the horizontal direction and the vertical direction, a different pixel originating from the same star as the pixel already determined to be a top may also be stored in the top candidate storage unit 227. Despite the coordinates of such a pixel having a vertical position adjacent to the position of the pixel determined to be a top and a similar horizontal position, the pixel is detected as a new top candidate. Here, at the top determination unit 228, since these pixels are determined as a pixel group originating from the same star, in a case where the vertical position and the horizontal position of the top candidate pixel is in a range specified by the vertical position and the horizontal position of the top determined pixel, the brightness value of the pixel with a higher brightness is kept as the top.

The top determination unit 228, on the basis of the top candidate (brightness difference), can estimate the top candidate pixel as the actual position of the star. In this manner, in the present embodiment, the top determination unit 228 functions as a position determination unit that determines the actual position of a star. The CPU 10 can estimate the attitude of the spacecraft on the basis of the actual position of a star determined by the top determination unit 228.

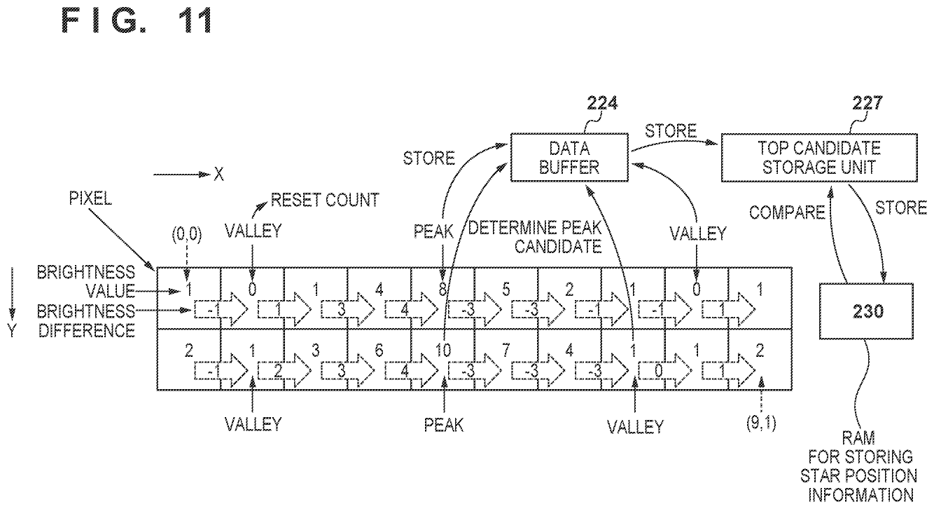

FIG. 11 is a diagram for describing an example of processing in the star position searching unit 220. The values inside the arrows in FIG. 11 represent the difference (brightness difference) between the brightness value of the target pixel and the brightness value of the preceding pixel. Note that in this example, the threshold A equals 1, the threshold B equals 4, and the range C equals 1. In a case where the star image is read from top-left, the brightness difference is calculated in the right direction from (X,Y)=(0,0). At (X,Y)=(1,0) to (2,0), the brightness difference switches from a negative value to 0 or greater. Thus, (X,Y)=(1,0), a preceding pixel, is determined to be a valley, and the count value is initialized. In a similar manner, (X,Y)=(4,0), a preceding pixel where the brightness difference has switched from 0 or greater to a negative value, is determined to be a mountain.

In the data buffer 224, the position and brightness value of a pixel determined to be a mountain are stored. Continuing the read, a valley is determined at (X,Y)=(8,0). Here, the count value, that is the width from valley to valley, is 7 pixels. Since 7 pixels satisfies the threshold B, the preceding (X,Y)=(4,0) determined to be a mountain and stored in the data buffer 224 is determined to be a top candidate.

In the top candidate storage unit 227, the position and brightness value of this pixel determined to be a mountain are stored. At this point in time, no data is stored in the RAM 230 for star position information storage. Thus, the processing from steps S233 to S236 by the top determination unit 228 described above is not executed, and the position and brightness value of the pixel stored in the top candidate storage unit 227 is stored in the RAM 230 for star position information storage.

When reading for Y=0 ends, reading for Y=1 is started. When reading for Y=1, (X,Y)=(1,1) is determined to be a valley, (X,Y)=(4,1) is determined to be a mountain, and the position and the brightness value of the pixel determined to be a mountain are stored in the data buffer 224. Furthermore, (X,Y)=(7,1) is determined to be a valley. The count value is 6 pixels.

6 pixels satisfies the threshold B. Thus, (X,Y)=(4,1) is determined to be a top candidate. In the top candidate storage unit 227, the position and brightness value of this pixel are stored. Here, in the RAM 230 for star position information storage, the position and brightness value of (X,Y)=(4,0) is already stored. Then, (X,Y)=(4,0) and (X,Y)=(4,1) satisfy existing in the range C. Thus, the brightness value of (X,Y)=(4,0) and the brightness value of (X,Y)=(4,1) are compared. The brightness value of (X,Y)=(4,1) is greater than the brightness value of (X,Y)=(4,0). Accordingly, the RAM 230 for star position information storage discards the position and the brightness value of (X,Y)=(4,0) and newly stores the position and brightness value of (X,Y)=(4,1).

Thus, the star image includes:

a pixel (reference pixel) determined to be a mountain,

a pixel (first pixel) determined to be a valley, that is, a preceding pixel where the brightness difference switches from a negative value to 0 or greater before the pixel determined to be a mountain, and

a pixel (second pixel) determined to be a valley, that is, a preceding pixel where the brightness difference switches from a negative value to 0 or greater after the pixel determined to be a mountain.

In a case where the distance (distance from a first criteria region to a second criteria region), which is the count value, between the two pixels determined to be valleys is equal to or greater than a threshold (the threshold B) (greater than a predetermined value), the star position searching unit 220 stores the position of the pixel determined to be a mountain as the position of a top candidate with the highest brightness. In other words, the threshold is set so that, when an image of an actual star is included in the star image and the size of the star is a size of a star targeted for detection, the count value for that star exceeds the threshold.

The two top candidate pixels, that is (X,Y)=(4,0) and (X,Y)=(4,1), are obtained at different timings and are temporarily stored in the data buffer 224. (X,Y)=(4,0) and (X,Y)=(4,1) exist in the range C. In other words, in a case where the position in the X direction of one top candidate and the position in the X direction of the other top candidate are the same, of the two top candidates, the top candidate with the highest brightness is stored and the top candidate with the lower brightness is deleted. In the present embodiment, the position and brightness value of (X,Y)=(4,1) is kept, and the position and brightness value of (X,Y)=(4,0) is discarded.

The star tracker 1 with this configuration determines or estimates a star position using the brightness difference between two adjacent pixels. Thus, in a case where the sun enters the field of view or an angle outside of the field of view with solar interference when the overall brightness of the captured image is increased, the star position estimation is resistant to the effects of an increase in the overall brightness of the captured image. Accordingly, the star position estimation accuracy is improved.

As a countermeasure against an increase in the overall brightness of an image, a conceivable method includes obtaining an average of brightness values of the overall image or with the image divided into a plurality of blocks and subtracting the average value from the brightness value of each pixel. With this method, a large amount of memory is required to store the data of the required amount of pixels. However, the star tracker 1 can execute top candidate determination by simply storing the data of a plurality of pixels before and after reading. Thus, the memory capacity can be reduced.

In the present embodiment described above, the FPGA 20 has the function of a brightness detection unit, the function of a calculation unit, and the function of a position determination unit, but no such limitation is intended, and, for example, it is sufficient that the FPGA 20 has at least one of these functions.

The star tracker 1 stores each pixel in order in the RAM 40, which is a storage apparatus. Between storing, brightness detection, brightness difference calculation, and estimation of the actual position of a star are executed in order by the FPGA 20. Accordingly, the amount of time needed to estimate the actual position of a star is less than a case where, for example, the pixel storage, the brightness detection, the brightness difference calculation, and the estimation of an actual position of a star are executed in order. Accordingly, the attitude of a spacecraft can be quickly estimated.

In the present embodiment, the distance (width from valley to valley) between two pixels determined to be valleys is compared to the threshold B as the count value. In the example described, a pixel determined to be a mountain existing between two valleys is determined to be a top candidate. However, this is merely an example. For example, the brightness gradient of a plurality of pixels existing before and after a pixel determined to be a mountain may have a correlation with the brightness gradient from an actual star. The determination condition may be set based on such a brightness gradient. In this manner, a top candidate may be determined on the basis of a set determination condition such as the distance between pixels or the like.

### Second Embodiment

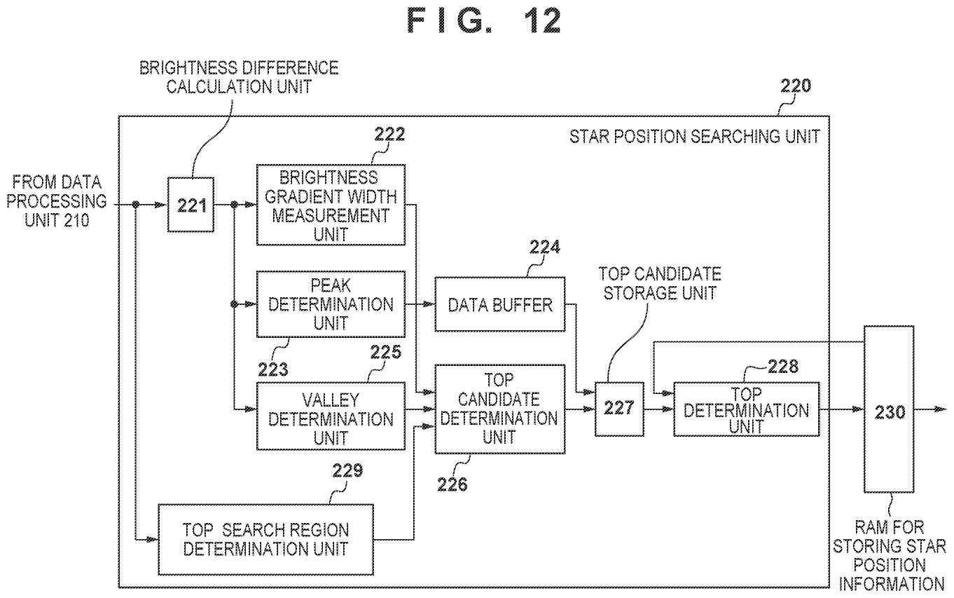

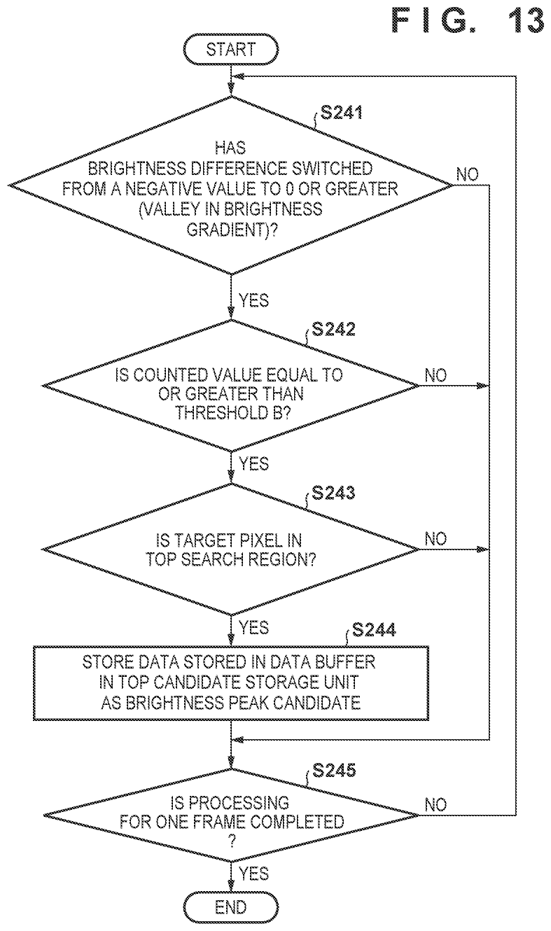

The second embodiment will be described below with reference to FIGS. 12 and 13. In the description, the differences with the embodiment described above will be focused on. Items that are similar will not be described. The difference between the first embodiment and the second embodiment lies in the hardware configuration of the star position searching unit 220. In other areas, the first embodiment and the second embodiment are similar. FIG. 12 is a block diagram illustrating a hardware configuration of the star position searching unit 220 according to the second embodiment.

As illustrated in FIG. 12, the star position searching unit 220 according to the second embodiment further includes a top search region determination unit 229. The top search region determination unit 229 determines whether or not the target pixel (pixel determined to be a mountain) is in a top search region surveyed for brightness top on the basis of information relating to the position in a pixel input from the data processing unit 210.

Note that as the top search region, for example, a region preset at the time of FPGA configuration may be used or a region set from the CPU 10 via the system bus 70 may be used. A determination signal (determination result) from the top search region determination unit 229 is input into the top candidate determination unit 226 and used in top candidate determination.

FIG. 13 is a flowchart illustrating the processing executed by the valley determination unit 225, the top candidate determination unit 226, and the top candidate storage unit 227. As illustrated in FIG. 13, in step S241, in a case where the brightness difference is input, the valley determination unit 225 determines whether or not the brightness difference has switched from a negative value to 0 or greater. In a case where the result of the determination in step S241 is that the brightness difference has switched from a negative value to 0 or greater, the processing proceeds to step S242. On the other hand, in a case where the result of the determination in step S241 is that the brightness difference has not switched from a negative value to 0 or greater, the processing proceeds to step S245.

In step S242, the valley determination unit 225 checks the value of the brightness gradient width counter of the brightness gradient width measurement unit 222 and determines whether or not the count value is equal to or greater than the threshold B. In a case where the result of the determination in step S242 is that the count value is equal to or greater than the threshold B, the processing proceeds to step S243. On the other hand, in a case where the result of the determination in step S242 is that the count value is not equal to or greater than the threshold B, the processing proceeds to step S245.

In step S243, the top candidate determination unit 226 determines whether or not the target pixel is in the top search region. In a case where the result of the determination in step S243 is that the target pixel is in the top search region, the processing proceeds to step S244. On the other hand, in a case where the result of the determination in step S243 is that the target pixel is not in the top search region, the processing proceeds to step S245.

In step S244, the top candidate determination unit 226 stores the pixel data corresponding to the mountain stored in the data buffer 224 in the top candidate storage unit 227 as a brightness top candidate.

In step S245, the top candidate determination unit 226 determines whether or not the processing up to step S244 has been completed for one whole frame. In a case where the result of the determination in step S245 is that one whole frame has been completed, the processing ends. On the other hand, in a case where the result of the determination in step S245 is that the processing has not been completed for one whole frame, the processing returns to step S241, and the following steps are executed in order.

When the sun is located in or near the angle of view, stray light may enter any region in the captured image due to the effects of a baffle shape of the like attached to the optical system of the image sensor. In a case where the stray light enters the star image, a brightness gradient is formed in a non-star region, causing a star position detection error. Regarding this, according to the present embodiment, by determining a region where stray light enters in advance, top searching can be executed in the other regions, and the effects of stray light can be kept to a minimum.

As illustrated in FIG. 1, the FPGA 20 is an example of an image processing circuit according to the present embodiment. However, all of the functions or one or more of the functions implemented by the FPGA 20 may be implemented by the CPU 10. Also, the FPGA 20 or the CPU 10 may be referred to as a processor.

The star tracker 1 is an example of an image capture apparatus or an image processing apparatus.

As illustrated in the example in FIG. 1, one image sensor 30 and one memory 40 are provided, but a plurality of the image sensors 30 and a plurality of the memories 40 may be implemented. In this case, the plurality of image sensors 30 have different fields of view or partially overlapping fields of view. The FPGA 20 or the CPU 10 executes sequential or parallel processing on n-number of images obtained by the n-number of the image sensors 30 and estimates the position of a foreign object or a star in each one of the n-number of images. Accordingly, in the case of parallel processing, the n-number of FPGAs 20 may execute processing on the n-number of images in parallel. In other words, the i-th FPGA 20, from among the n-number of FPGAs 20, executes processing on the corresponding i-th image, from among the n-number of images. Here, i is an index and an integer from 1 to n.

In the embodiment described above, a star is the capturing object, and the position of the star is estimated. However, this is merely an example. The capturing object may be an item produced by a production apparatus. In this case, the position of a foreign object existing on the item is estimated. In this manner, with an inspection apparatus that inspects for foreign objects that have a certain amount of brightness, there may be cases when a light source with high brightness exists in the field of view of the image sensor 30 or exists outside of the field of view but causes stray light in the field of view. The technical concept according to the present embodiment is applicable to such a foreign object inspection. In other words, the technical concept can be used in an image processing circuit, an image processing apparatus, an inspection apparatus, an information processing apparatus, a computer, and an image capture apparatus that detects or estimates the position of a detection target with a certain amount of brightness.

The invention is not limited to the foregoing embodiments, and various variations/changes are possible within the spirit of the invention.

What is claimed is:

1. An image processing circuit comprising:
an image capture unit configured to capture an image of a capturing object and obtain an image of the capturing object;
a brightness detection unit configured to detect brightness in each criteria region in the image obtained by the image capture unit;
a computation unit configured to compute a difference in the brightness of two adjacent criteria regions detected by the brightness detection unit; and
a position determination unit configured to determine a position of the capturing object in the image corresponding to a pixel having a brightness greater than a predetermined value on a basis of the difference in the brightness computed by the computation unit.

2. The image processing circuit according to claim 1, wherein
the criteria region is one pixel in the image.

3. The image processing circuit according to claim 1, wherein
the image capture unit includes an image sensor configured to capture the image, and
the brightness detection unit, when detecting the brightness, reads the criteria region in order in a read out direction of the image from the image sensor.

4. The image processing circuit according to claim 3, wherein
the computation unit computes the difference in the brightness by subtracting a brightness of a second criteria region, of the two adjacent criteria regions, located behind in a reading direction of the brightness detection unit from a brightness of a first criteria region, of the two adjacent criteria regions, located in front in the reading direction.

5. The image processing circuit according to claim 4, further comprising:
a storage unit configured to store a position of a preceding pixel, the preceding pixel being the first criteria region where the difference in the brightness switches from 0 or greater to a negative value, wherein
the storage unit stores, as a top candidate with the brightness at a maximum, a position of the preceding pixel in a case where a distance from a first pixel to a second pixel is greater than a specified value, the first pixel being the criteria region where the difference in the brightness switches from a negative value to 0 or greater before the preceding pixel, and the second pixel being the criteria region where the difference in the brightness switches from a negative value to 0 or greater after the preceding pixel.

6. The image processing circuit according to claim 5, wherein
the position determination unit determines an actual position of the capturing object on a basis of the top candidate.

7. The image processing circuit according to claim 5, wherein
in a case where two top candidates obtained at different timing are temporarily stored and positions of the two top candidates are in a predetermined range, the storage unit stores, of the two top candidates, the top candidate with the higher brightness and deletes the top candidate with the lower brightness.

8. The image processing circuit according to claim 5, wherein
in the image, a search region surveyed for the preceding pixel can be set.

9. The image processing circuit according to claim 5, wherein
the storage unit stores the brightness of the first pixel and the brightness of the second pixel, the brightness of the first pixel and the brightness of the second pixel being used as a condition for the top candidate.

10. The image processing circuit according to claim 1, further comprising:
a storage unit configured to store a plurality of criteria regions in order, wherein
while the storage unit is storing the plurality of criteria regions in order, detection of the brightness by the brightness detection unit, computation of the difference in the brightness by the computation unit, and determination of an actual position of the capturing object by the position determination unit are executed in order.

11. The image processing circuit according to claim 1, further comprising:
a field programmable gate array (FPGA); and
a central processing unit (CPU) communicatively connected to the FPGA, wherein
the FPGA includes at least one of the brightness detection unit, the computation unit, and the position determination unit.

12. The image processing circuit according to claim 1, wherein
the image processing circuit is installed in an image capture apparatus.

13. The image processing circuit according to claim 1, wherein
the capturing object is a star,
the image processing circuit is a star tracker installed in a spacecraft, and
an attitude determining unit configured to determine an attitude of the spacecraft on a basis of a position of the star determined by the position determination unit is further provided.

14. A method for determining a position of a capturing object comprising:
capturing an image of the capturing object and obtaining an image of the capturing object;
detecting brightness in each criteria region in the image obtained by the capturing;
computing a difference in the brightness of two adjacent criteria regions detected by the detecting; and
determining an actual position of the capturing object on a basis of the difference in the brightness computed in the computing.

15. A non-transitory computer-readable storage medium storing a program, the program causing a computer to execute:
capturing an image of a capturing object and obtaining an image of the capturing object;
detecting brightness in each criteria region in the image obtained by the capturing;
computing a difference in the brightness of two adjacent criteria regions detected by the detecting; and
determining an actual position of the capturing object on a basis of the difference in the brightness computed in the computing.

16. An image processing apparatus comprising:
an image sensor configured to capture an image of a capturing object and obtain an image of the capturing object; and
at least one processor configured to execute a plurality of image processing on the image, wherein the plurality of image processing includes
detecting brightness in each criteria region in the image obtained by the image sensor,
computing a difference in the brightness of two adjacent criteria regions detected by the detecting, and
determining a position of the capturing object in the image corresponding to a pixel having a brightness greater than a predetermined value on a basis of the difference in the brightness computed by the computing.
